(19) United States
(12) Patent Application Publication
(10) Pub. No.: US 2022/0365183 A1
(43) Pub. Date: Nov. 17, 2022

(54) LASER RANGING METHOD, APPARATUS, STORAGE MEDIUM, AND LIDAR

(71) Applicant: SUTENG INNOVATION TECHNOLOGY CO., LTD., Shenzhen (CN)

(72) Inventor: Zhaohui SHI, Shenzhen (CN)

(73) Assignee: SUTENG INNOVATION TECHNOLOGY CO., LTD., Shenzhen (CN)

(21) Appl. No.: 17/868,661

(22) Filed: Jul. 19, 2022

Related U.S. Application Data
(63) Continuation of application No. PCT/CN2020/073251, filed on Jan. 20, 2020.

(51) Int. Cl. G01S 7/4865; G01S 17/10

(52) U.S. Cl. CPC G01S 7/4865; G01S 17/10

(57) ABSTRACT

Embodiments of this application disclose a laser ranging method, apparatus, and LiDAR, and pertain to the ranging field. The method includes: emitting a ranging laser signal; receiving a reflected laser signal formed after the ranging laser signal is reflected by a target object; determining a first measured distance value based on a time difference between an emitting time of the ranging laser signal and a receiving time of the reflected laser signal; determining a second measured distance value of an internal signal link; and obtaining an actual distance value of the target object based on the first measured distance value and the second measured distance value. In the embodiments of this application, stability of the measured actual distance value of the target object can be ensured when an environmental factor changes. Impact of the environmental factor on the laser ranging is reduced, and precision of the laser ranging is improved.

### CROSS-REFERENCE TO RELATED APPLICATION

The present application is a continuation of International Application No. PCT/CN2020/073251, filed on Jan. 20, 2020, the content of which is incorporated herein by reference in its entirety.

### TECHNICAL FIELD

This application relates to the ranging field, and in particular, to a laser ranging method, apparatus, storage medium, and LiDAR.

### BACKGROUND

LiDAR is a radar system that emits a laser beam to detect relevant parameters of a target object. A working principle of the LiDAR is to emit a detection laser beam to the target object, then compare received signals reflected from the target with emission signals, and properly process the signals to obtain the relevant parameters of the target object, such as distance, azimuth, height, speed, attitude, shape, and other parameters of the target object.

A current LiDAR generally has a built-in photoelectric receiving device. The built-in photoelectric receiving device converts optical signals reflected by the target object into analog electrical signals, and then transfers the analog electrical signals to an analog-to-digital converter (ADC). The analog-to-digital converter converts the analog electrical signals into digital signals. The digital signals are then subjected to a signal processing procedure, such as detection, to obtain a measured distance value of the target object relative to the LiDAR.

However, the inventor finds that electronic devices in the LiDAR, such as a laser, a photoelectric receiving element, a chip, a capacitor, and a resistor, are sensitive to environmental parameters (such as temperature, humidity, or air pressure). For a target object at the same position, distance values measured under different environmental parameters may greatly vary, which causes inaccuracy of a ranging result, thereby affecting ranging accuracy of the LiDAR.

### SUMMARY

Embodiments of this application provide a laser ranging method, apparatus, and LiDAR, so that an inaccuracy problem of a ranging result caused by a change in an environmental parameter in the related art can be resolved. Technical solutions are as follows:

According to a first aspect, an embodiment of this application provides a laser ranging method, where the method includes:
emitting a ranging laser signal;
receiving a reflected laser signal, wherein the reflected laser signal is formed after the ranging laser signal is reflected by a target object;
determining a first measured distance value based on a time difference between an emitting time of the ranging laser signal and a receiving time of the reflected laser signal;
determining a second measured distance value of an internal signal link; and
obtaining an actual distance value of the target object based on the first measured distance value and the second measured distance value.

In a possible embodiment, determining a second measured distance value of an internal signal link includes:
generating a first reference electrical signal;
performing electro-optical conversion on the first reference electrical signal to obtain an preamble optical signal, and emitting the preamble optical signal;
receiving an echo optical signal corresponding to the preamble optical signal; and
determining the second distance value of the internal signal link based on a time difference between an emitting time of the preamble optical signal and a receiving time of the echo optical signal.

In a possible embodiment, determining a second measured distance value of an internal signal link includes:
generating a second reference electrical signal;
determining transmission duration of the second reference electrical signal in the internal signal link; and
determining the second measured distance value of the internal signal link based on the transmission duration.

In a possible embodiment, the internal signal link includes an internal emission link and an internal receiving link. The internal emission link includes a control unit, a drive unit, and a laser device. The internal receiving link includes a photoelectric receiving device, an analog-to-digital converter, and the control unit.

In a possible embodiment, the obtaining the actual distance value of the target object based on the first measured distance value and the second measured distance value includes:
calculating the actual distance value of the target object according to the following formula:
   1/2×(c×T1−c×T2), where c represents a speed of light, T1 represents the time difference between an emitting time of the ranging laser signal and a receiving time of the reflected laser signal, and T2 represents the time difference between the emitting time of the preamble optical signal and the receiving time of the echo optical signal; or T2 represents the transmission duration of the second reference electrical signal in the internal signal link.

In a possible design, the reference signal and the ranging laser signal are sent at the same time.

Alternatively, in a possible embodiment, the preamble optical signal and the second reference electrical signal are sent based on a preset period.

Alternatively, in a possible embodiment, the preamble optical signal and the second reference electrical signal are sent when a power-on instruction is detected

Alternatively, in a possible embodiment, emission power of the preamble optical signal is less than emission power of the ranging laser signal.

In a possible embodiment, the second measured distance value is obtained by performing weighted averaging on a plurality of measured distance values of the internal signal link from repeated measurements.

According to a second aspect, an embodiment of this application provides a laser ranging apparatus, including:
an emission unit, configured to emit a ranging laser signal;
a receiving unit, configured to receive a reflected laser signal, where the reflected laser signal is formed after the ranging laser signal is reflected by a target object; and
a control unit, configured to determine a first measured distance value based on a time difference between an emitting time of the ranging laser signal and a receiving time of the reflected laser signal,
where the control unit is further configured to determine a second measured distance value of an internal signal link; and
where the control unit is further configured to obtain an actual distance value of the target object based on the first measured distance value and the second measured distance value.

According to a third aspect, an embodiment of this application provides a computer storage medium. The computer storage medium stores a plurality of instructions. The instructions are adapted to be loaded by a processor to execute the steps of the foregoing method.

According to a fourth aspect, an embodiment of this application provides LiDAR, including a processor and a memory. The memory stores a computer program. The computer program is adapted to be loaded by the processor to execute the foregoing method.

The beneficial effects provided by the technical solutions of some embodiments of the present application include at least:

When a target object needs to be ranged, the ranging laser signal is emitted. The reflected laser signal formed after the ranging laser signal is reflected by the target object is received. The first measured distance value is determined based on the time difference between the ranging laser signal and the reflected laser signal. The second measured distance value of the internal signal link is determined, and the actual distance value of the target object is obtained based on the first measured distance value and the second measured distance value. The embodiments of this application focus on the measured distance value of the internal signal link when the target object is ranged, which can alleviate the LiDAR's inaccuracy problem of the measured distance value of the target object, which is caused because a performance of an electronic device changes due to the changes of the environmental parameter, and improve stability of the LiDAR for the measured distance values under different environmental parameters, thereby improving measurement precision of the LiDAR.

### BRIEF DESCRIPTION OF DRAWINGS

To explain embodiments of the present application or the technical solutions in the prior art more clearly, the following briefly introduces the drawings that need to be used in the embodiments or the prior art. Obviously, the drawings in the following description are only some embodiments of the present application. The person skilled in the art may obtain other drawings based on these drawings without inventive labor.

FIG. 1 is a schematic diagram of a laser ranging principle according to an embodiment of this application;

FIG. 2 is a schematic diagram of a measured distance value under impact of an environmental parameter according to an embodiment of this application;

FIG. 3 is a schematic flowchart of a laser ranging method according to an embodiment of this application;

FIG. 4 is a schematic diagram of an internal signal link according to an embodiment of this application;

FIG. 5 is a schematic diagram of an internal signal link according to an embodiment of this application;

FIG. 6 is a schematic diagram of a ranging principle according to an embodiment of this application;

FIG. 7 is a schematic structural diagram of a laser ranging apparatus according to this application; and

FIG. 8 is another schematic structural diagram of LiDAR according to this application.

### DETAILED DESCRIPTION

To make objectives, technical solutions and advantages of the present application clearer, embodiments of the present application are described in further detail below with reference to the drawings.

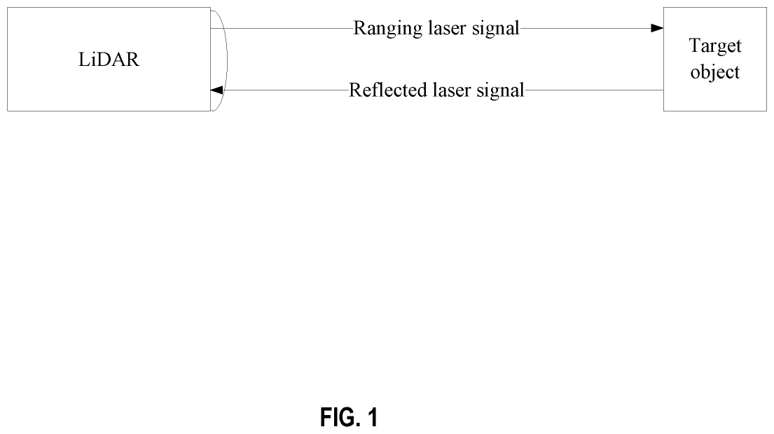

FIG. 1 is a schematic diagram of a laser ranging principle in a related art. In FIG. 1, the LiDAR emits a ranging laser signal, and the ranging laser signal may be a pulse signal or a continuous signal. This is not limited in the embodiments of this application. A target object is arranged in front of the LiDAR, and a reflected laser signal is formed after the ranging laser signal is reflected by the target object. The LiDAR receives the reflected laser signal, and the LiDAR determines a time difference between an emitting time of the ranging laser signal and a receiving time of the reflected laser signal. Then one half of a product of a speed of light and the time difference is used as a measured distance value of the target object.

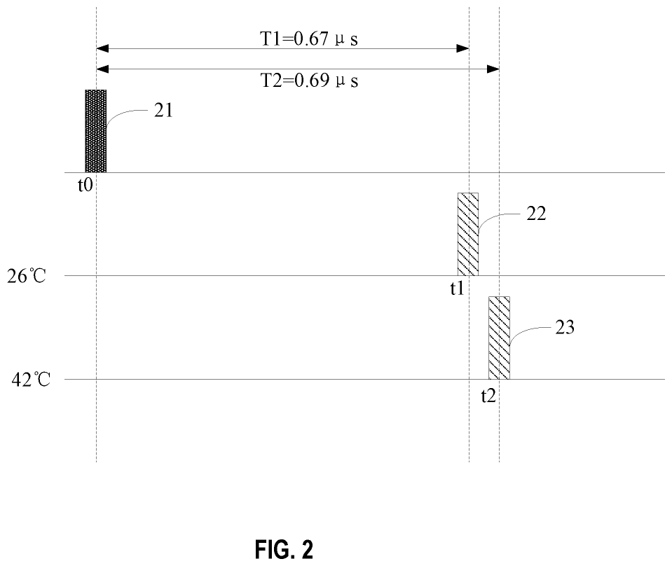

In a ranging process using the laser, the inventor finds that an environmental parameter has an impact on the measured distance value of the target object. For a target object in the same position, measured distance values of the target object under different environmental parameters vary greatly. For example, as shown in FIG. 2, at an ambient temperature of 26° C., the LiDAR emits a ranging laser signal 21 at a time t0, and then the LiDAR receives a reflected laser signal 22 at a time t1, a time difference between the emitting time of the ranging laser signal 21 and the receiving time of the reflected laser signal 22 is T1, T1=0.67 μs. Therefore, a measured value of the target object is: c×T1/2, where c represents the speed of light. At an ambient temperature of 42° C., the LiDAR emits the ranging laser signal 21 at the time t0, and then the LiDAR receives the reflected laser signal 23 at a time t2. A time difference between the emitting time of the ranging laser signal 21 and the receiving time of the reflected laser signal 23 is T2, T2=0.69 μs. Therefore, a measured distance value of the current object that is calculated by the LiDAR is: c×T2/2, where c represents the speed of light. It can be seen that at ambient temperatures of 42° C. and 26° C., a difference between measured values of the target object that are obtained by the LiDAR is: c×(T2−T1)/2=300000×103×0.02×10×10−6/2=30 meters, and the measured distance values at the same position under different temperature vary greatly, which affects precision and accuracy of ranging.

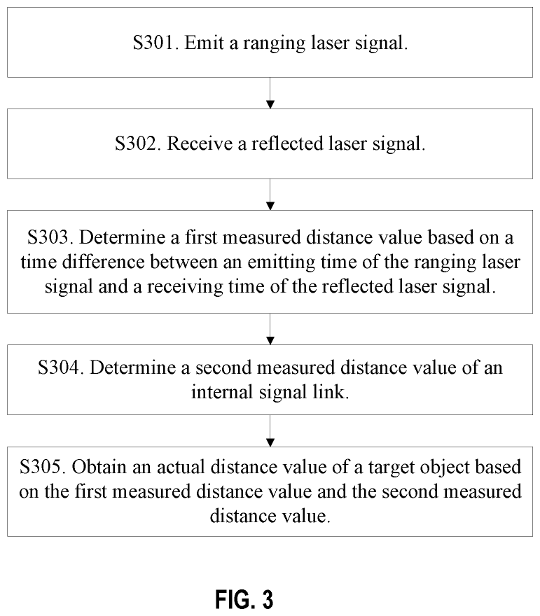

As shown in FIG. 3, FIG. 3 is a schematic flowchart of a laser ranging method according to an embodiment of this application. As shown in FIG. 3, the method in this embodiment of this application may include the following steps:

S301. Emit a ranging laser signal.

A control unit controls an emission unit to emit the ranging laser signal. The emission unit includes a drive unit and a laser device. The control unit sends laser parameter information to the drive unit and the laser parameter information includes parameters such as an emission time, emission power, and duration of the ranging laser signal, The drive unit instructs, based on the laser parameter information, the laser device to emit the ranging laser signal, and the ranging laser signal is used to range the target object.

S302. Receive a reflected laser signal.

The reflected laser signal is formed after the ranging laser signal is reflected by the target object. The control unit receives the reflected laser signal by using the receiving unit. The receiving unit may include a photoelectric converter and an analog-to-digital converter. The photoelectric converter is configured to convert the reflected laser signal from an optical signal to an analog electrical signal. The analog-to-digital converter is configured to convert the electrical signal into a digital signal. The control unit further processes a digital signal.

S303. Determine a first measured distance value based on a time difference between an emitting time of the ranging laser signal and a receiving time of the reflected laser signal.

The control unit records the emitting time of the ranging laser signal and the receiving time of the reflected laser signal, and the control unit determines the first measured distance value based on the emitting time of the ranging laser signal and the receiving time of the reflected laser signal.

For example, the control unit records the emitting time of the ranging laser signal as t1 and the receiving time of the reflected laser signal as t2. The first measured distance value calculated by the control unit is: 1/2×c×(t2−t1), where c is the speed of light.

S304. Determine a second measured distance value of an internal signal link.

The internal signal link is a signal link inside the LiDAR. The signal link includes an electronic device, an optical device, an optoelectronic device, and the like inside the LiDAR. Therefore, the signal link is a wired signal link and does not include an external wireless signal link. The internal signal link includes an emission signal link and a receiving signal link. The second measured distance value of the internal signal link may be pre-stored, or may be measured before the emission of the ranging laser signal.

In a possible embodiment, determining a second measured distance value of an internal signal link includes:
generating a second reference electrical signal;
determining transmission duration of the second reference electrical signal in the internal signal link; and
determining the second measured distance value of the internal signal link based on the transmission duration.

The internal signal link can include an internal emission link and an internal receiving link. The second reference electrical signal is generated in the internal emission link and then directly transmitted to the internal receiving link without being subjected to electro-optical conversion. That is, the second reference electrical signal is only transmitted within the internal signal link without generating a laser signal to detect an object. Because the second reference electrical signal does not need to be used for ranging, emission power of the second reference electrical signal may be less than that of an electrical signal corresponding to the ranging laser signal used for ranging.

Further, the internal emission link includes a control unit, a drive unit, and a laser device. The internal receiving link includes a photoelectric receiving device, an analog-to-digital converter, and the control unit.

The control unit may be implemented in at least one hardware form of digital signal processing (DSP), a field-programmable gate array (FPGA), and a programmable logic array (PLA). The drive unit is configured to drive, based on the laser parameter information sent from the control unit, the laser device to emit a laser signal. The laser parameter information includes parameters such as the emitting time, the number of emissions, emission power, and duration. The laser device can be one or more laser diodes, and a plurality of laser diodes can form an emission array. The photoelectric receiving device is configured to convert the laser signal into an analog electrical signal, the photoelectric receiving device can be a photodiode, and the analog-to-digital converter is configured to convert the analog electrical signal into a digital signal to be further processed by the control unit.

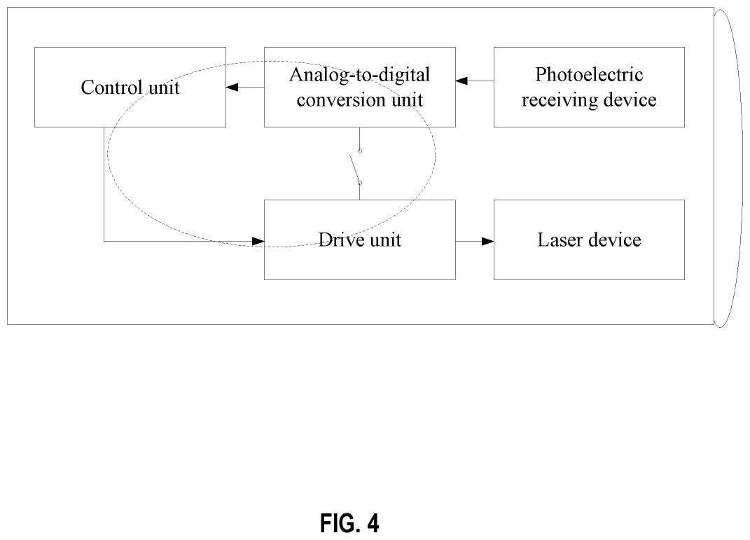

For example, referring to FIG. 4, FIG. 4 is a schematic diagram of a transmission path of a second reference electrical signal. A switch device is arranged between an analog-to-digital conversion unit and a drive unit. The control unit controls the switch device to remain in a turn-on state when the second measured distance value is measured, so that the drive unit and the analog-to-digital conversion unit are directly connected. The control unit generates the second reference electrical signal and the second reference electrical signal reaches the control unit after passing through the drive unit and the analog-to-digital conversion unit. The control unit receives the second reference electrical signal. The control unit determines a time difference based on an emitting time and a receiving time of the second reference electrical signal, and determines the second measured distance value of the internal signal link based on the time difference.

In another possible embodiment, determining a second measured distance value of an internal signal link includes:
generating a first reference electrical signal;
performing electro-optical conversion on the first reference electrical signal to obtain a preamble optical signal, and emitting the preamble optical signal;
receiving an echo optical signal corresponding to the preamble optical signal, where the echo optical signal is formed after the preamble optical signal reaches a light receiving device; and
determining the second measured distance value of the internal signal link based on a time difference between an emitting time of the preamble optical signal and a receiving time of the echo optical signal.

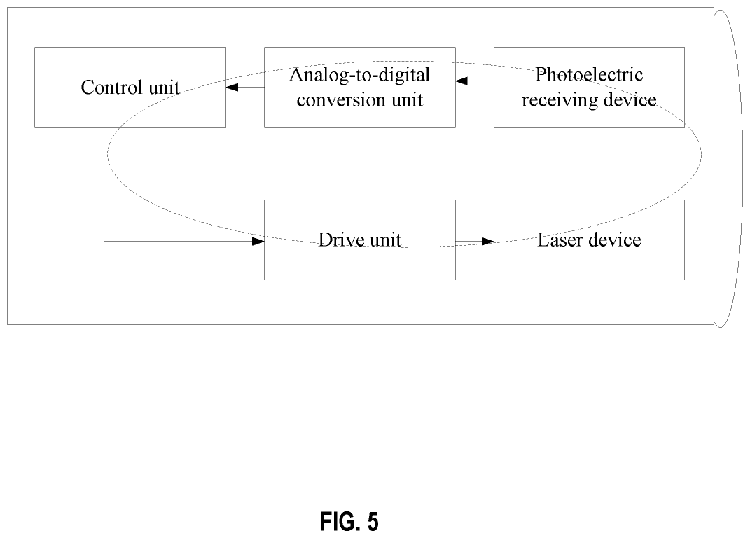

For example, as shown in FIG. 5, the control unit generates a first reference electrical signal. The first reference electrical signal carries laser parameter information. The control unit sends the first reference electrical signal to the drive unit, and the drive unit drives, based on the laser parameter information, the laser device to emit the preamble optical signal. The preamble optical signal reaches the photoelectric receiving device after being transmitted within the LiDAR. The photoelectric receiving device receives the echo optical signal and converts the echo optical signal into an analog electrical signal. The analog-to-digital converter converts the electrical signal into a digital signal. The control unit receives the digital signal and determines the second measured distance value based on an emitting time of the preamble optical signal and a receiving time of the echo optical signal.

In a possible embodiment, the preamble optical signal, the second reference electrical signal, and the ranging laser signal are sent at the same time.

Alternatively, in a possible embodiment, the preamble optical signal and the second reference electrical signal are sent based on a preset period.

Alternatively, in a possible embodiment, the preamble optical signal and the second reference electrical signal are sent when a power-on instruction is detected.

Alternatively, in a possible embodiment, emission power of the preamble optical signal is less than emission power of the ranging laser signal.

A process of generating the preamble optical signal includes: When a laser beam generated by the laser device reaches an optical device, a part of the laser beam is certainly reflected by the optical device. Reflection on a beam splitter is the most obvious, and the reflected part of the laser beam is the preamble optical signal. Because the laser beam (the preamble optical signal) is not transmitted outside the LiDAR and is transmitted in a short distance, the loss is small. Amplitude of the reflected laser beam received by the optoelectronic device is the maximum. However, when the LiDAR is in a normal condition of detecting an object, amplitude of the reflected laser beam received by the optoelectronic device needs to be attenuated to detect the object normally. However, in this embodiment of this application, the reflected laser beam does not need to be attenuated, and the received laser with the maximum amplitude corresponds to the preamble optical signal.

In a possible embodiment, the second measured distance value is obtained by performing weighted averaging on a plurality of measured distance values of the internal signal link from repeated measurements.

The number of measurements may depend on an actual need. This is not limited in this embodiment of this application. A weighted averaging method includes arithmetic averaging or geometric averaging, and a weighted coefficient of each measured distance value may depend on an actual need. For example, weighted coefficients of measured distance values are equal.

S305. Obtain an actual distance value of the target object based on the first measured distance value and the second measured distance value.

The actual measured distance value is obtained by deducting the second measured distance value from the first measured distance value. For example, if the first measured distance value is 1000 meters and the second measured value is 30 meters, the actual distance value is 970 meters. The actual distance value of the target object that is calculated based on this embodiment can still remain stable when an environmental parameter changes.

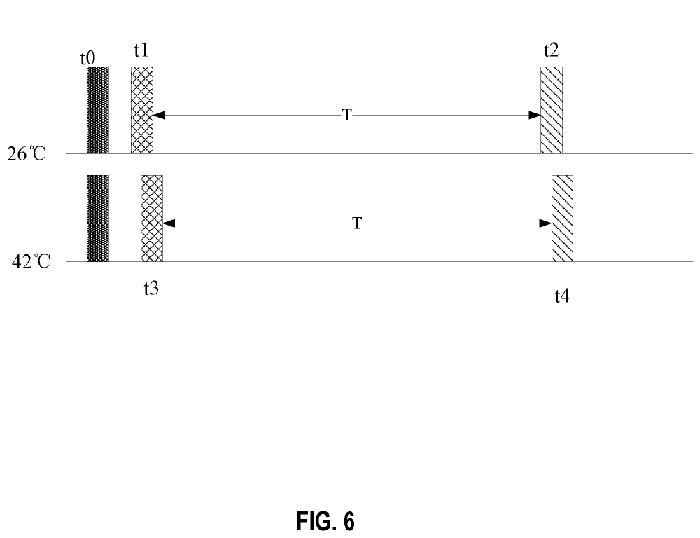

For example, as shown in FIG. 6, at an ambient temperature of 26° C., the LiDAR simultaneously sends the ranging laser signal and the preamble optical signal at a time t0, then receives the echo optical signal at a time t1, and receives the reflected laser signal at a time t2. The LiDAR determines a time difference T between the time t1 and the time t2, and then calculates the actual distance value of the target object based on the speed of light and the time difference T. The time difference between the time t0 and the time t1 indicates transmission time of the preamble optical signal inside the LiDAR. A distance S1 from the beam splitter of the LiDAR to the laser device and the optical receiver is calculated based on the time difference. The time difference between the time t0 and the time t2 represents the sum of transmission time of the ranging laser signal from the laser device to the object and transmission time of the echo optical signal from the object to the light receiving device. A distance S2 from the laser device to the object is calculated based on the time difference. A difference between the distance S2 and the distance S1 represents the actual distance between the beam splitter and the object. A distance measurement error of the LiDAR is eliminated in a differential method so that ranging is more accurate. At an ambient temperature of 42° C., the LiDAR simultaneously sends the ranging laser signal and the preamble optical signal at a time t0, then receives the echo optical signal at a time t3, and receives the reflected laser signal at a time t4. The LiDAR determines a time difference T between the time t3 and the time t4. The time difference is equal to the time difference at the ambient temperature of 26° C. Therefore, the actual distance value of the target object that is obtained by the LiDAR at the ambient temperature of 42° C. is equal to the actual distance value of the target object obtained at the ambient temperature of 26° C. The time difference between the time t0 and the time t3 indicates transmission time of the preamble optical signal inside the LiDAR. A distance S2 from the beam splitter of the LiDAR to the laser device and the optical receiver is calculated based on the time difference. The time difference between the time t0 and the time t4 represents the sum of transmission time of the ranging laser signal from the laser device to the object and transmission time of the echo optical signal from the object to the light receiving device. A distance S3 from the laser device to the object is calculated based on the time difference. A difference between the distance S3 and the distance S2 represents the actual distance between the beam splitter and the object. A distance measurement error of the LiDAR is eliminated via the differential method so that ranging is more accurate.

For another example, as shown in FIG. 6, at the ambient temperature of 26° C., the LiDAR simultaneously sends the ranging laser signal and the second reference electrical signal at a time t0, then receives the second reference electrical signal again at a time t1, and receives the reflected laser signal at a time t2. The LiDAR determines a time difference T between the time t1 and the time t2, and then calculates the actual distance value of the target object based on the speed of light and the time difference T. At an ambient temperature of 42° C., the LiDAR simultaneously sends the ranging laser signal and the second reference electrical signal at a time t0, then receives the second reference electrical signal at a time t3, and receives the reflected laser signal at a time t4. The LiDAR determines a time difference T between the time t3 and the time t4. The time difference is equal to the time difference at the ambient temperature of 26° C. Therefore, the actual distance value of the target object that is obtained by the LiDAR at the ambient temperature of 42° C. is equal to the actual distance value of the target object obtained at the ambient temperature of 26° C. For a process of calculating the actual distance value, refer to the foregoing process with respect to the preamble optical signal. Details are described herein again.

Further, the obtaining the actual distance value of the target object based on the first measured distance value and the second measured distance value includes:
calculating the actual distance value of the target object according to the following formula:
   1/2×(c×T1−c×T2), where c represents a speed of light, T1 represents a time difference between an emitting time of the ranging laser signal and a receiving time of the reflected laser signal, and T2 represents a time difference between the preamble optical signal and the echo optical signal; or T2 represents transmission duration of the second reference electrical signal in the internal signal link.

During implementation of this embodiment of this application, when the target object needs to be ranged, the ranging laser signal is emitted, and the reflected laser signal formed after the ranging laser signal is reflected by the target object is received. The first measured distance value is determined based on the time difference between the ranging laser signal and the reflected laser signal. The second measured distance value of the internal signal link is determined, and the actual distance value of the target object is obtained based on the first measured distance value and the second measured distance value. In this embodiment of this application, when the target object is ranged, the measured distance value obtained through the ranging laser signal and the measured distance value of the internal signal link are subjected to differential processing, to eliminate an error for the internal signal link, which can alleviate the LiDAR's inaccuracy problem of the measured distance value of the target object, which is caused because a performance of an electronic device changes due to the change of the environmental parameter, and improve stability of the LiDAR for the measured distance values under different environmental parameters, thereby improving measurement precision of the LiDAR.

A device embodiment of this application is provided below and can be used to perform the method embodiments of this application. For details not disclosed in this device embodiment of this application, refer to the method embodiments of this application.

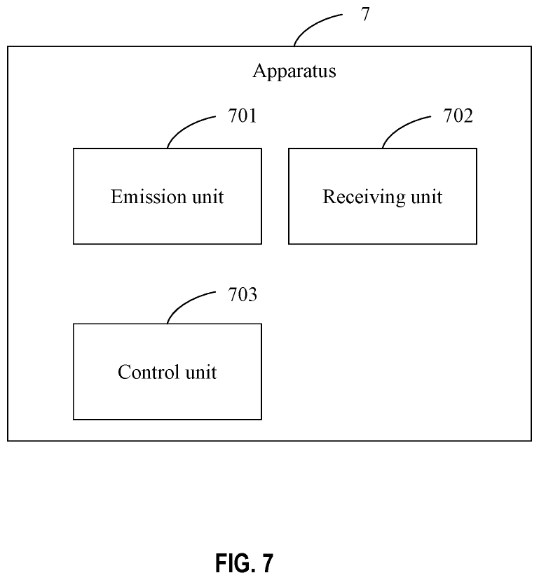

Referring to FIG. 7, FIG. 7 is a schematic structural diagram of a laser ranging apparatus according to an example embodiment of this application. The laser ranging apparatus is referred to as an apparatus 7 below. The apparatus 7 can be implemented as all or a part of the LiDAR through software, hardware, or a combination of thereof. The apparatus 7 includes an emission unit 701, a receiving unit 702, and a control unit 703.

The emission unit 701 is configured to emit a ranging laser signal. The receiving unit 702 is configured to receive a reflected laser signal, where the reflected laser signal is formed after the ranging laser signal is reflected by a target object. The control unit 703 is configured to determine a first measured distance value based on a time difference between an emitting time of the ranging laser signal and a receiving time of the reflected laser signal. The control unit 703 is further configured to determine a second measured distance value of an internal signal link. The control unit 703 is further configured to obtain an actual distance value of the target object based on the first measured distance value and the second measured distance value.

In a possible embodiment, determining a second measured distance value of an internal signal link includes:
generating a first reference electrical signal;
performing electro-optical conversion on the first reference electrical signal to obtain an preamble optical signal, and emitting the preamble optical signal;
receiving an echo optical signal corresponding to the preamble optical signal, where the echo optical signal is formed after the preamble optical signal reaches a light receiving device; and
determining the second measured distance value of the internal signal link based on a time difference between the emitting time of the preamble optical signal and the receiving time of the echo optical signal.

In a possible embodiment, determining a second measured distance value of an internal signal link includes:
generating a second reference electrical signal;
determining transmission duration of the second reference electrical signal in the internal signal link; and
determining the second measured distance value of the internal signal link based on the transmission duration.

In a possible embodiment, the internal signal link includes an internal emission link and an internal receiving link. The internal emission link includes a control unit, a drive unit, and a laser device. The internal receiving link includes a photoelectric receiving device, an analog-to-digital converter, and the control unit.

In a possible embodiment, obtaining an actual distance value of the target object based on the first measured distance value and the second measured distance value includes:
calculating the actual distance value of the target object according to the following formula:
   1/2×(c×T1−c×T2), where c represents a speed of light, T1 represents a time difference between an emitting time of the ranging laser signal and a receiving time of the reflected laser signal, and T2 represents a time difference between an emitting time of the preamble optical signal and a receiving time of the echo optical signal, or represents transmission duration of the second reference electrical signal in the internal signal link.

In a possible embodiment, the preamble optical signal, the second reference electrical signal, and the ranging laser signal are sent at the same time.

Alternatively, in a possible embodiment, the preamble optical signal, the preamble optical signal and the second reference electrical signal are sent based on a preset period.

Alternatively, in a possible embodiment, the preamble optical signal and the second reference electrical signal are sent when a power-on instruction is detected.

In a possible embodiment, the second measured distance value is obtained by performing weighted averaging on a plurality of measured distance values of the internal signal link from repeated measurements.

It should be noted that, when the apparatus 7 provided in the foregoing embodiment performs the laser ranging method, division of the foregoing functional modules is only used as an example for illustration. In actual application, the foregoing functions can be allocated to different functional modules for implementation based on a need, that is, an inner structure of the device is divided into different functional modules to implement all or some of the functions described above. In addition, embodiments of the laser ranging apparatus and the laser ranging method provided above pertain to the same concept. For a specific implementation process, refer to the method embodiments. Details are not described herein again.

Serial numbers of the embodiments of this application are only intended for description, and do not indicate advantages or disadvantages of the embodiments.

An embodiment of this application also provides a computer storage medium. The computer storage medium may store a plurality of instructions. The instructions are capable of being loaded by a processor to perform the steps of the method in the embodiments shown in FIGS. 3-6. For a specific execution process, refer to the specific description of the embodiments shown in FIGS. 3-6. Details are not described herein again.

This application also provides a computer program product. The computer program product stores at least one instruction. The at least one instruction is loaded and executed by the processor to implement a laser ranging method described in each of the above embodiments.

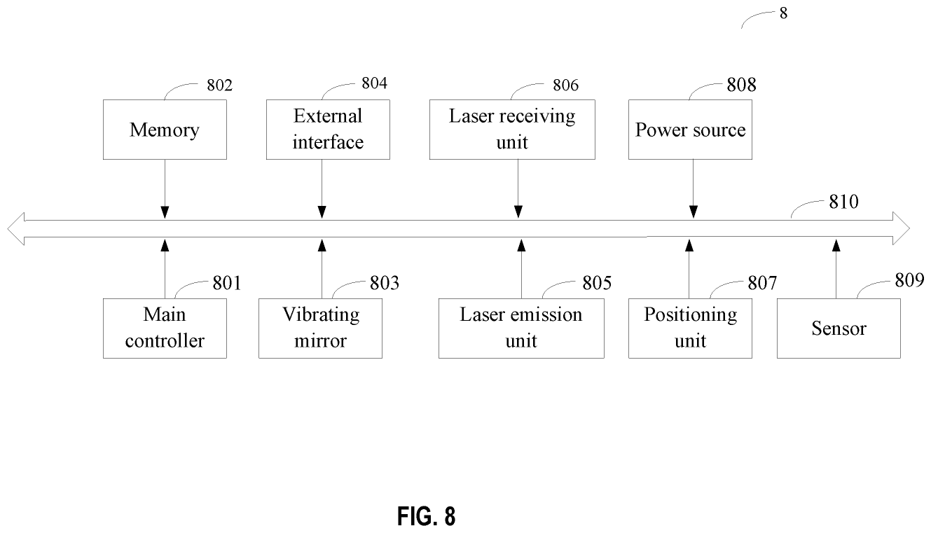

Referring to FIG. 8, FIG. 8 is a schematic structural diagram of LiDAR according to an embodiment of this application. As shown in FIG. 8, LiDAR 8 may include at least one main controller 801, a memory 802, a vibrating mirror 803, and at least one communication bus 810.

The communication bus 810 is configured to implement a connection and communication between various components in the LiDAR. For example, the communication bus 810 is a CAN (controller area network) bus.

The LiDAR 8 further includes an external interface 804, a laser emission unit 805, a laser receiving unit 806, a positioning unit 807, a power source 808, and a sensor 809. The external interface 804 is used for data transmission with a peripheral device. For example, the external interface 804 includes a serial port, a local area network interface, and the like. The laser emission unit 805 is configured to emit a laser for detecting an object. The laser emission unit 805 may include a boost power source, an LD driving switch, a laser device, an emission temperature control unit, and a power source. The laser receiving unit 806 receives a laser reflected by the object. The power source 808 is configured to provide a working voltage for the LiDAR. The positioning unit 807 is configured to obtain position information. For example, the positioning unit 807 may be a GPS (Global Positioning System) positioning unit. The sensor 809 is configured to measure an environmental parameter or an attitude parameter. For example, the sensor 809 includes a temperature sensor and an attitude sensor, the temperature sensor is configured to detect ambient temperature, and the attitude sensor is configured to detect a current attitude.

The main controller 801 may include one or more processing cores. The main controller 801 uses various interfaces and lines to connect various parts of the entire LiDAR 8, and executes various functions and processes data of the LiDAR 8 by running or executing instructions, programs, code sets, or instruction sets stored in the memory 802, and invoking data stored in the memory 802. Optionally, the main controller 801 may be realized in at least one hardware form of digital signal processing (DSP), a field-programmable gate array (FPGA), and a programmable logic array (PLA). The main controller 801 may integrate a combination of one or more of a central processing unit (CPU), a graphics processing unit (GPU), a modem, and the like. The CPU is configured to process an operating system, a user interface, an application program, and the like. The GPU is configured to render and draw content that needs to be displayed on a display. The modem is configured to process wireless communication. It may be understood that the foregoing modem may not be integrated into the main controller 801 and may be implemented by one chip independently.

The memory 802 may include a random access memory (RAM), or a read-only memory (ROM). Optionally, the memory 802 includes a non-transitory computer-readable medium. The memory 802 may be configured to store the instructions, the programs, the codes, the code sets or the instruction sets. The memory 802 may include a program storage region and a data storage region. The program storage region may store instructions for implementing the operating system, instructions for at least one function (such as a touch control function, a sound play function, and an image play function), and instructions for implementing each of the foregoing method embodiments. The data storage region may store the data involved in each of the above embodiments. Optionally, the memory 802 may also be at least one storage apparatus away from the foregoing main controller 801.

In the LiDAR 8 shown in FIG. 8, the main controller 801 may be configured to invoke the computer program stored in the memory 802, and specifically execute the following steps:
emitting, by the laser emission unit 805, a ranging laser signal;
receiving, by the laser receiving unit 806, a reflected laser signal, where the reflected laser signal is formed after the ranging laser signal is reflected by a target object;
determining a first measured distance value based on a time difference between an emitting time of the ranging laser signal and a receiving time of the reflected laser signal;
determining a second measured distance value of an internal signal link; and
obtaining an actual distance value of the target object based on the first measured distance value and the second measured distance value.

In a possible embodiment, determining, by the main controller 801, a second measured distance value of an internal signal link includes:
generating a first reference electrical signal;
performing electro-optical conversion on the first reference electrical signal to obtain a preamble optical signal, and emitting the preamble optical signal;
receiving an echo optical signal corresponding to the preamble optical signal, where the echo optical signal is formed after the preamble optical signal reaches a light receiving device; and
determining the second measured distance value of the internal signal link based on a time difference between an emitting time of the preamble optical signal and a receiving time of the echo optical signal.

In a possible embodiment, determining, by the main controller 801, a second measured distance value of an internal signal link includes:
generating a second reference electrical signal;
determining transmission duration of the second reference electrical signal in the internal signal link; and
determining the second measured distance value of the internal signal link based on the transmission duration.

In a possible embodiment, the internal signal link includes an internal emission link and an internal receiving link. The internal emission link includes a control unit, a drive unit, and a laser device. The internal receiving link includes a photoelectric receiving device, an analog-to-digital converter, and the control unit.

In a possible embodiment, obtaining, by the main controller 801, an actual distance value of the target object based on the first measured distance value and the second measured distance value includes:
calculating the actual distance value of the target object according to the following formula:
   1/2×(c×T1−c×T2), where c represents a speed of light, T1 represents a time difference between an emitting time of the ranging laser signal and a receiving time of the reflected laser signal, and T2 represents a time difference between an emitting time of the preamble optical signal and a receiving time of the echo optical signal.

In a possible embodiment, the preamble optical signal and the ranging laser signal are sent at the same time.

Alternatively, in a possible embodiment, the preamble optical signal is sent based on a preset period.

Alternatively, in a possible embodiment, the preamble optical signal is sent when a power-on instruction is detected.

Alternatively, in a possible embodiment, emission power of the preamble optical signal is less than emission power of the ranging laser signal.

In a possible embodiment, obtaining, by the main controller 801, an actual distance value of the target object based on the first measured distance value and the second measured distance value includes:
calculating the actual distance value of the target object according to the following formula:
   1/2×(c×T1−c×T2), where c represents a speed of light, T1 represents a time difference between an emitting time of the ranging laser signal and a receiving time of the reflected laser signal, and T2 represents transmission duration of the second reference electrical signal in the internal signal link.

In a possible embodiment, the second reference electrical signal and the ranging laser signal are sent at the same time.

Alternatively, in a possible embodiment, the second reference electrical signal is sent based on a preset period.

Alternatively, in a possible embodiment, the second reference electrical signal is sent when a power-on instruction is detected.

Alternatively, in a possible embodiment, emission power of the second reference electrical signal is less than emission power of the ranging laser signal.

In a possible embodiment, the second measured distance value is obtained by performing weighted averaging on a plurality of measured distance values of the internal signal link from repeated measurements.

The embodiment in FIG. 8 and the method embodiment in FIG. 3 are based on the same concept and have the same technical effects. For a specific implementation process of FIG. 8, refer to the description of FIG. 3. Details are not described herein again.

The person skilled in the art can understand that all or part of procedures in methods of the foregoing embodiments can be implemented by instructing relevant hardware via computer program. The program can be stored in a computer readable storage medium. During execution, the computer program can include the procedures of the embodiments of the foregoing methods. A storage medium can be a magnetic disk, an optical disc, the read-only storage memory or the random storage memory, and so on.

The disclosed foregoing are only preferred embodiments of the present application, which of course cannot be used to limit the scope of rights of the present application. Therefore, equivalent changes made in accordance with the claims of the present application still fall within the scope of the application.

What is claimed is:

1. A laser ranging method, comprising:
emitting a ranging laser signal;
receiving a reflected laser signal, wherein the reflected laser signal is formed after the ranging laser signal is reflected by a target object;
determining a first measured distance value based on a time difference between an emitting time of the ranging laser signal and a receiving time of the reflected laser signal;
determining a second measured distance value of an internal signal link; and
obtaining an actual distance value of the target object based on the first measured distance value and the second measured distance value.

2. The laser ranging method according to claim 1, wherein the determining the second measured distance value of the internal signal link comprises:
generating a first reference electrical signal;
performing electro-optical conversion on the first reference electrical signal to obtain a preamble optical signal, and emitting the preamble optical signal;
receiving an echo optical signal corresponding to the preamble optical signal, wherein the echo optical signal is formed when the preamble optical signal reaches a light receiving device; and
determining the second measured distance value of the internal signal link based on a time difference between an emitting time of the preamble optical signal and a receiving time of the echo optical signal.

3. The laser ranging method according to claim 2, wherein the obtaining the actual distance value of the target object based on the first measured distance value and the second measured distance value comprises:
calculating the actual distance value of the target object according to the following formula:
1/2×(c×T1−c×T2), wherein c represents a speed of light, T1 represents the time difference between the emitting time of the ranging laser signal and the receiving time of the reflected laser signal, and T2 represents the time difference between the emitting time of the preamble optical signal and the receiving time of the echo optical signal.

4. The laser ranging method according to claim 2, wherein the preamble optical signal and the ranging laser signal are sent at the same time.

5. The laser ranging method according to claim 2, wherein the preamble optical signal is sent based on a preset period.

6. The laser ranging method according to claim 2, wherein the preamble optical signal is sent when a power-on instruction is detected.

7. The laser ranging method according to claim 2, wherein emission power of the preamble optical signal is less than emission power of the ranging laser signal.

8. The laser ranging method according to claim 1, wherein the determining the second measured distance value of the internal signal link further comprises:
generating a second reference electrical signal;
determining transmission duration of the second reference electrical signal in the internal signal link; and
determining the second measured distance value of the internal signal link based on the transmission duration.

9. The laser ranging method according to claim 8, wherein the obtaining the actual distance value of the target object based on the first measured distance value and the second measured distance value comprises:
calculating the actual distance value of the target object according to the following formula:
1/2×(c×T1−c×T2), wherein c represents a speed of light, T1 represents the time difference between the emitting time of the ranging laser signal and the receiving time of the reflected laser signal, and T2 represents transmission duration of the second reference electrical signal in the internal signal link.

10. The laser ranging method according to claim 8, wherein the second reference electrical signal and the ranging laser signal are sent at the same time.

11. The laser ranging method according to claim 8, wherein the second reference electrical signal is sent based on a preset period.

12. The laser ranging method according to claim 8, wherein the second reference electrical signal is sent when a power-on instruction is detected.

13. The laser ranging method according to claim 1, wherein the internal signal link comprises an internal emission link and an internal receiving link,
wherein the internal emission link comprises a control unit, a drive unit, and a laser device, and
wherein the internal receiving link comprises a photoelectric receiving device, an analog-to-digital converter, and the control unit.

14. The laser ranging method according to claim 1, wherein the second measured distance value is obtained by performing weighted averaging on a plurality of measured distance values of the internal signal link from repeated measurements.

15. A laser ranging apparatus, wherein the apparatus comprises:
an emission unit, configured to emit a ranging laser signal;
a receiving unit, configured to receive a reflected laser signal, wherein the reflected laser signal is formed after the ranging laser signal is reflected by a target object; and
a control unit, configured to determine a first measured distance value based on a time difference between an emitting time of the ranging laser signal and a receiving time of the reflected laser signal,
wherein the control unit is further configured to determine a second measured distance value of an internal signal link, and
wherein the control unit is further configured to obtain an actual distance value of the target object based on the first measured distance value and the second measured distance value.

16. A LiDAR, comprising a processor and a memory, wherein the memory stores a computer program, and the computer program is capable of being loaded by the processor to perform a method which further comprises:
emitting a ranging laser signal;
receiving a reflected laser signal, wherein the reflected laser signal is formed after the ranging laser signal is reflected by a target object;
determining a first measured distance value based on a time difference between an emitting time of the ranging laser signal and a receiving time of the reflected laser signal;
determining a second measured distance value of an internal signal link; and
obtaining an actual distance value of the target object based on the first measured distance value and the second measured distance value.
